(19) United States
(12) Patent Application Publication
(10) Pub. No.: US 2026/0121199 A1
(43) Pub. Date: Apr. 30, 2026

(54) BATTERY MODULE

(71) Applicant: HONDA MOTOR CO., LTD., Tokyo (JP)

(72) Inventors: Wataru Ohira, Wako-shi (JP); Shigeru Takeda, Wako-shi (JP)

(21) Appl. No.: 19/363,922

(22) Filed: Oct. 21, 2025

(30) Foreign Application Priority Data
Oct. 25, 2024 (JP) 2024-188359

(51) Int. Cl. H01M 50/262; B64D 27/357; H01M 10/04; H01M 10/625; H01M 10/647; H01M 10/6554; H01M 10/6567; H01M 50/211; H01M 50/242

(52) U.S. Cl. CPC H01M 50/262; H01M 10/0481; H01M 10/625; H01M 10/647; H01M 10/6554; H01M 10/6567; H01M 50/211; H01M 50/242; B64D 27/357; H01M 2220/20

(57) ABSTRACT

A battery module includes a cell stack including a battery cell and a heat exchanger stacked on the battery cell, a holding mechanism including a pair of holding portions configured to hold the cell stack by pressing, inward in a stacking direction of the cell stack, both end portions of the cell stack in the stacking direction, and a connecting member configured to connect the pair of holding portions to each other, and a detachment prevention mechanism provided at the heat exchanger and preventing, by abutting against the connecting member, the heat exchanger from being detached from the cell stack.

### CROSS-REFERENCE TO RELATED APPLICATIONS

This application is based upon and claims the benefit of priority from Japanese Patent Application No. 2024-188359 filed on Oct. 25, 2024, the contents of which are incorporated herein by reference.

### BACKGROUND OF THE INVENTION

### Field of the Invention

The present disclosure relates to a battery module.

### Description of the Related Art

A battery module is disclosed in JP 2023-101130 A. A battery module is provided with a cell stack and a holding mechanism. The cell stack is constructed by stacking battery cells and heat exchangers. The holding mechanism holds the cell stack by applying a tightening load from both sides of the cell stack in the stacking direction. The holding mechanism prevents the movement of the battery cells and the heat exchanger.

### SUMMARY OF THE INVENTION

A technology that can better hold a cell stack is needed.

The present disclosure aims to solve the aforementioned problems.

A battery module according to one aspect of the present disclosure includes: a cell stack including a battery cell and a heat exchanger stacked on the battery cell; a holding mechanism including a pair of holding portions configured to hold the cell stack by pressing, inward in a stacking direction of the cell stack, both end portions of the cell stack in the stacking direction, and a connecting member configured to connect the pair of holding portions to each other; and a detachment prevention mechanism provided at the heat exchanger and preventing, by abutting against the connecting member, the heat exchanger from being detached from the cell stack.

According to the present disclosure, the cell stack can be well held.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a battery module according to an embodiment;

FIG. 2 is an exploded perspective view of a cell stack;

FIG. 3 is a cross-sectional view taken along the line III-III of FIG. 1;

FIG. 4A is a diagram showing a detachment prevention mechanism provided in a first heat exchanger, and FIG. 4B is a diagram showing a detachment prevention mechanism provided in a second heat exchanger;

FIG. 5A is a diagram showing another example of the configuration of the detachment prevention mechanism provided in the first heat exchanger, and FIG. 5B is a diagram showing another example of the configuration of the detachment prevention mechanism provided in the second heat exchanger;

FIG. 6 is a perspective view of a battery module according to a first modified example;

FIG. 7 is a cross-sectional view taken along line VII-VII of FIG. 6;

FIG. 8 is a cross-sectional view of a battery module according to a second modified example; and

FIG. 9 is a schematic diagram of an aircraft in which the battery module is mounted.

### DETAILED DESCRIPTION OF THE INVENTION

When a cell stack is held solely by a frictional force caused by a pressing force applied from a holding mechanism, if force exceeding the holding force caused by the frictional force acts on the cell stack, the heat exchanger is shifted (displaced) in a direction intersecting the stacking direction of the cell stack. To prevent the shift, it is considered to improve the pressing force (tightening force) given by the holding mechanism, but it is necessary to improve the rigidity of the battery cell and the heat exchanger. However, if the rigidity of the battery cell and the heat exchanger is increased, there is a concern that the clamping force acting on the battery cell may become excessive when the battery cell expands. According to the embodiment shown below, it is possible to hold the cell stack favorably.

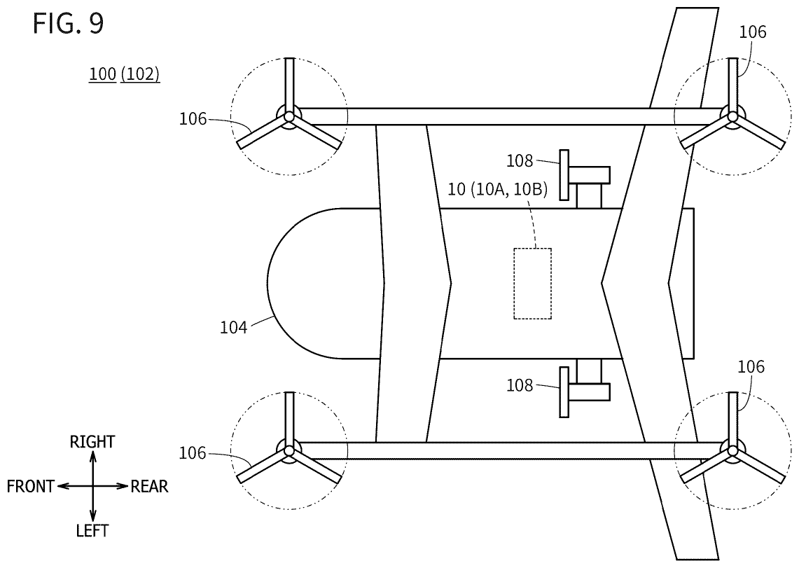

As shown in FIG. 9, a battery module 10 according to an embodiment is mounted on, for example, an aircraft 102, which is an instance of a mobile body 100. The aircraft 102 is, for example, an electric vertical take-off and landing aircraft (eVTOL). The aircraft 102 includes a fuselage 104, multiple (e.g., four) VTOL rotors 106, and multiple (e.g., two) cruise rotors 108.

The VTOL rotor 106 generates an upward thrust force with respect to the aircraft 102. The cruise rotor 108 generates a horizontal thrust force with respect to the aircraft 102. The battery module 10 is placed inside the fuselage 104. The battery module 10 supplies power to an electric motor (not shown) that drives each of the VTOL rotors 106 and the cruise rotors 108. The mobile body 100 may also be, for example, a vehicle, a ship, or the like. The battery module 10 is not limited to the example where the battery module 10 is mounted in the mobile body 100.

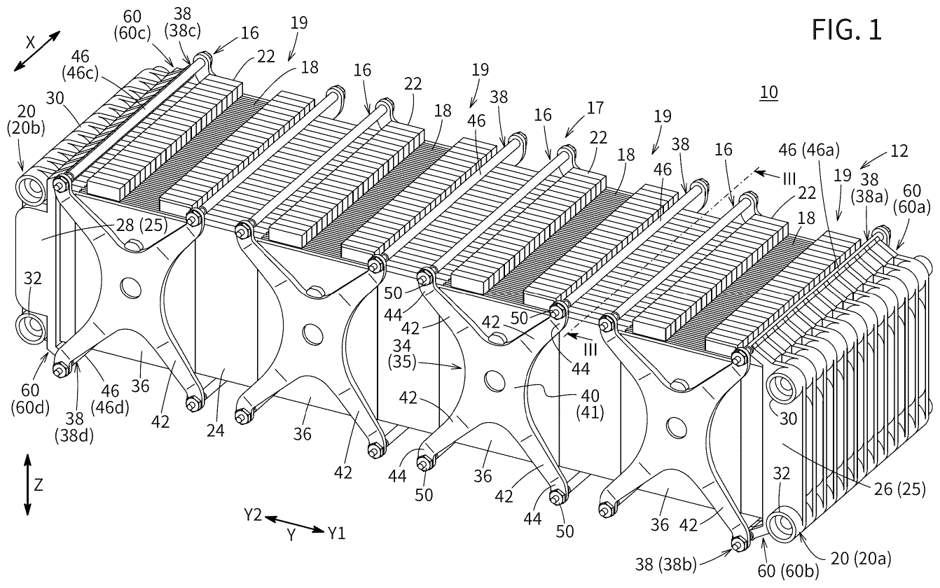

As shown in FIG. 1, the battery module 10 includes a cell stack 12 and a plurality of battery frames 16. In this embodiment, the battery frames 16 constitute a holding mechanism 17 that holds the cell stack 12.

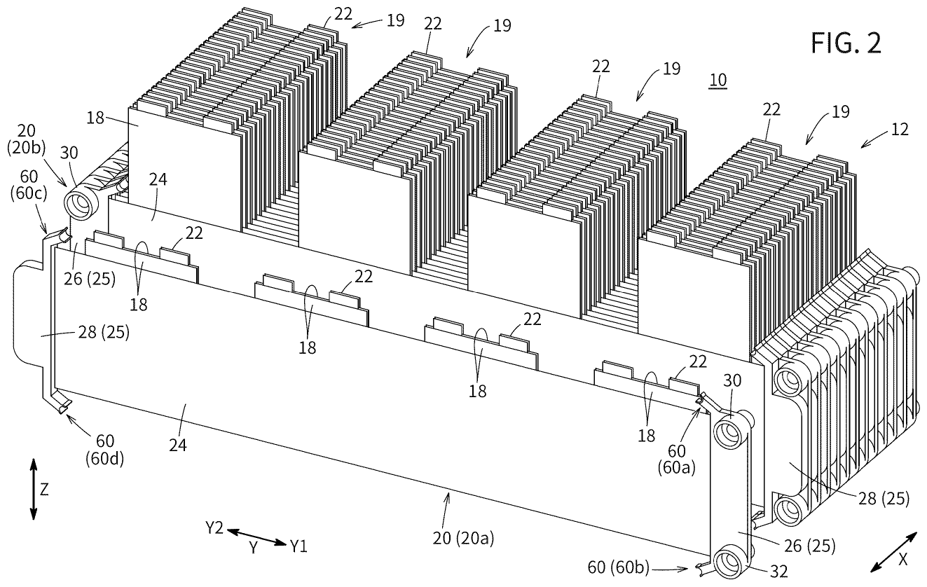

As shown in FIG. 2, the cell stack 12 includes a plurality of battery cells 18 and a plurality of heat exchangers 20. A single cell row 19 is formed of the battery cells 18 arranged in the direction of the arrow X. In this embodiment, four cell rows 19 are arranged in the direction of the arrow Y. The number of cell rows 19 may be three or less, or four or more. Only one cell row 19 may be provided in the battery module 10.

The battery cells 18 and the heat exchangers 20 are arranged (stacked) in the direction of the arrow X. In the following, the X direction is also referred to as “stacking direction”. In addition, the direction toward the center of the battery module 10 in the X direction is expressed as “inward in the stacking direction”. The direction away from the center of the battery module 10 in the X direction is expressed as “outward in the stacking direction”.

The battery cell 18 is a laminate type battery. The battery cell 18 is formed in a rectangular plate shape. A plurality of terminal portions 22 project from one side of the battery cell 18, the side being in the direction of the arrow Z. The battery cells 18 are connected in series with each other via the terminal portions 22. The terminal portions 22 are conceptually illustrated. Electrical connecting members (not shown) are bonded to the terminal portions 22.

The heat exchangers 20 include a plurality of first heat exchangers 20a and a plurality of second heat exchangers 20b.

Each of the first heat exchangers 20a has a heat exchange plate 24 and a pair of headers 25.

The heat exchange plate 24 is a plate-like water jacket. The heat exchange plate 24 is constructed of a metallic material, e.g., aluminum or copper. The heat exchange plate 24 extends in the direction of the arrow Y. The pair of headers 25 are provided at both ends of the heat exchange plate 24. The pair of headers 25 are made of, for example, plastic. The pair of headers 25 are a water supply-drainage header 26 and a turn header 28.

A flow path through which cooling water flows is formed inside the heat exchange plate 24. Although not shown in detail, this flow path has a forward flow path for letting cooling water flow from the water supply-drainage header 26 toward the turn header 28 and a return flow path for letting cooling water flow from the turn header 28 toward the water supply-drainage header 26.

The water supply-drainage header 26 is one of the pair of headers 25 provided in the first heat exchanger 20a. The water supply-drainage header 26 is provided at one end portion (Y1 direction side) of the heat exchange plate 24 in the longitudinal direction (direction of the arrow Y). The water supply-drainage header 26 supplies and drains cooling water to and from the heat exchange plate 24. The water supply-drainage header 26 has a water supply port 30 and a water drainage port 32.

The water supply port 30 is provided on an upper portion of the water supply-drainage header 26. The water supply port 30 supplies cooling water to the forward flow path of the heat exchange plate 24. The water supply ports 30 of the first heat exchangers 20a adjacent to each other are connected liquid-tightly to each other.

The drainage port 32 discharges the cooling water from the return flow path of the heat exchange plate 24. The drainage port 32 is provided at a lower portion of the water supply-drainage header 26. The drainage ports 32 of the first heat exchangers 20a adjacent to each other are connected liquid-tightly to each other. Contrary to the above configuration, the water supply port 30 may be provided at the lower portion of the water supply-drainage header 26, and the water drainage port 32 may be provided at the upper portion of the water supply-drainage header 26.

Although the details are not illustrated, the water supply ports 30 of the first heat exchangers 20a adjacent to each other are connected to be relatively movable in the X direction so that the expansion of the battery cells 18 in the X direction caused by heat generation or deterioration of the battery cells 18 can be absorbed. Similarly, the drainage ports 32 of the first heat exchangers 20a adjacent to each other are connected to each other to be relatively movable in the X direction.

The turn header 28 is the other of the pair of headers 25 provided in the first heat exchanger 20a. The turn header 28 is provided at the other end portion (Y2 direction side) of the heat exchange plate 24 in the longitudinal direction. For this reason, the heat exchange plate 24 is arranged between the water supply-drainage header 26 and the turn header 28. The turn header 28 receives cooling water from the forward flow path of the heat exchange plate 24 and lets the cooling water flow to the return flow path of the heat exchange plate 24.

The second heat exchanger 20b has the heat exchange plate 24 and a pair of header 25 (the water supply-drainage header 26 and the turn header 28), as the first heat exchanger 20a. However, in the Y-direction, the second heat exchanger 20b is oriented differently from the first heat exchanger 20a. Therefore, in the case of the second heat exchanger 20b, the water supply-drainage header 26 is arranged on the Y2 direction side of the heat exchange plate 24, and the turn header 28 is arranged on the Y1 direction side of the heat exchange plate 24.

The first heat exchanger 20a and the second heat exchanger 20b are alternately arranged in the direction of the arrow X. Thus, the water supply-drainage header 26 of one of the first heat exchanger 20a and the second heat exchanger 20b and the turn header 28 of the other of the first heat exchanger 20a and the second heat exchanger 20b are adjacent to each other in the stacking direction (X direction).

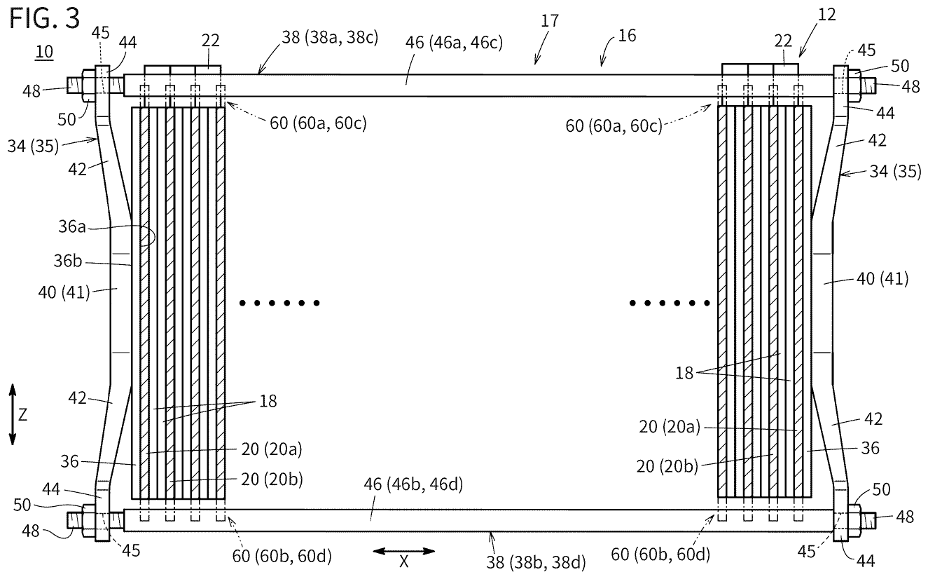

As shown in FIG. 3, two battery cells 18 are stacked in the direction of the arrow X between the first heat exchanger 20a and the second heat exchanger 20b that are adjacent to each other.

As shown in FIG. 1, in this embodiment, four battery frames 16 are provided corresponding to the four cell rows 19. The number of battery frames 16 may be three or less or five or more depending on the number of cell rows 19.

As shown in FIG. 3, each of the battery frames 16 constituting the holding mechanism 17 includes a pair of holding plates 34, a pair of pressure-receiving plates 36, and four connecting members 38 (see FIG. 1). The pair of holding plates 34 are placed at the end portions of the battery module 10 in the direction of the arrow X.

In the present embodiment, the pair of holding plates 34 are a pair of holding portions 35 that hold the cell stack 12. The pair of holding plates 34 are positioned outside the cell stack 12 in the stacking direction. The pair of holding plates 34 hold the cell stack 12 by pressing the stacking-direction opposite ends of the cell stack 12 inward in the stacking direction.

Specifically, the holding plate 34 presses the cell stack 12 in the stacking direction via the pressure-receiving plate 36. The pressure-receiving plate 36 is placed between the holding plate 34 and the cell stack 12.

The connecting members 38 connect the pair of holding plates 34 to each other in such a way that the tightening load (compressive load) is applied from the pair of holding plates 34 to the cell stack 12. This suppresses expansion of the battery cell 18.

The holding plate 34 is made of, for example, titanium alloy. The holding plate 34 may be made of a metal material other than titanium alloy.

As shown in FIG. 1, the holding plate 34 is formed in an X-shape when viewed from the thickness direction (the direction of the arrow X) of the holding plate 34. The holding plate 34 has a point-symmetric shape when viewed in the direction of the arrow X. The holding plate 34 includes a plate central portion 40 and four arm portions 42.

The plate central portion 40 is a pressing portion 41 that presses the cell stack 12 in the stacking direction via the pressure-receiving plate 36. The plate central portion 40 is placed at a central portion of the holding plate 34.

The four arm portions 42 extend radially from the plate central portion 40. The four arm portions 42 are provided at equal intervals in the circumferential direction of the plate central portion 40. The arm portion 42 is a leaf spring portion that is elastically deformed when a tightening load is applied to the cell stack 12. The number of arm portions 42 is not limited to four but may be three or five or more.

An attachment portion 44 is provided at an end portion in the extending direction of the arm portion 42. The connecting members 38 are connected to the attachment portion 44. As shown in FIG. 3, the attachment portion 44 is formed with an insertion hole 45 through which the bolt portion 48 of the connecting member 38 is inserted.

As shown in FIG. 1, the attachment portion 44 is located more outward than the cell stack 12 when viewed from the stacking direction (the direction of the arrow X) of the battery cells 18. The attachment portion 44 does not overlap with the terminal portion 22 when viewed from the direction of the arrow X.

The pressure-receiving plate 36 is a pressing plate for evenly applying to the cell stack 12 the tightening load exerted from the holding plate 34. The pressure-receiving plate 36 is formed in a quadrilateral shape. As shown in FIG. 3, a first surface 36a of the pressure-receiving plate 36 facing the cell stack 12 is in surface contact with an end surface of the cell stack 12. A second surface 36b of the pressure-receiving plate 36 facing in the direction opposite to the cell stack 12 is in surface contact with the plate central portion 40 of the holding plate 34. The battery frame 16 may omit the pressure-receiving plate 36.

As shown in FIG. 1, with the holding plate 34 being attached to the pressure-receiving plate 36, the four arm portions 42 extend, overlapping respectively with four corner portions of the pressure-receiving plate 36 when viewed in the direction of the arrow X. As shown in FIG. 3, with the holding plate 34 being attached to the pressure-receiving plate 36, a gap is provided between the arm portion 42 and the corner portions of the pressure-receiving plate 36. As shown in FIG. 1, with the holding plate 34 being attached to the pressure-receiving plate 36, the four attachment portions 44 are located more outward than the pressure-receiving plate 36 when viewed in the direction of the arrow X.

The connecting member 38 is located outside the cell stack 12. The connecting member 38 is located more inward in the Y-direction than the pair of headers 25. As shown in FIG. 3, the connecting member 38 includes a connecting shaft 46, two bolt portions 48, and two nuts 50.

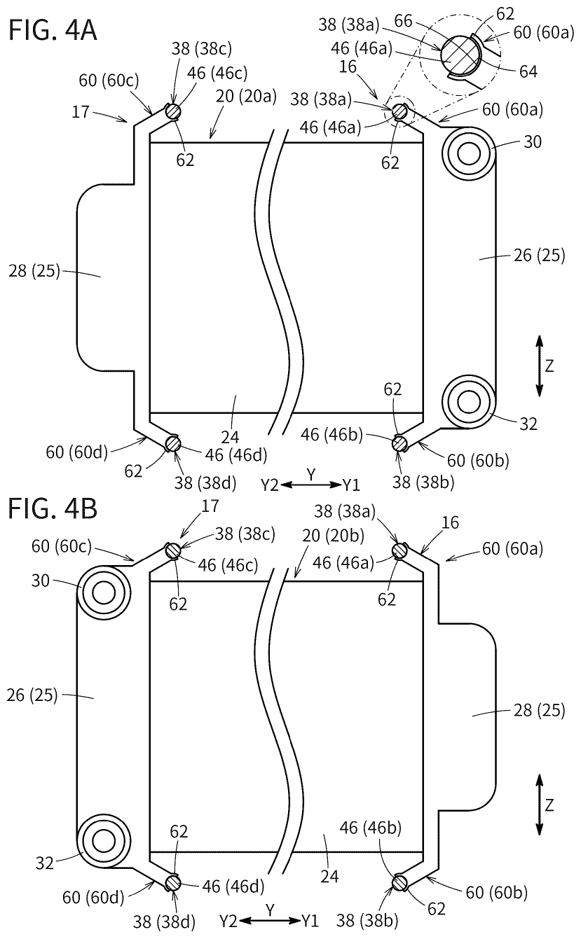

The connecting shaft 46 extends along the stacking direction (X-direction) of the battery cells 18. The connecting shaft 46 is made of, for example, a metallic material, such as stainless steel. As shown in FIGS. 4A and 4B, the cross-sectional shape of the connecting shaft 46 in the plane orthogonal to the axial direction of the connecting shaft 46 is circular. That is, the connecting shaft 46 is a cylindrical rod. The cross-sectional shape of the connecting shaft 46 is not limited to a circular shape but may be, for example, an oval shape, a quadrilateral shape, or the like.

As shown in FIG. 3, the bolt portion 48 protrudes from an axial end face of the connecting shaft 46. The bolt portion 48 is inserted through the insertion hole 45 of the attachment portion 44. The nut 50 is screwed into the bolt portion 48. The attachment portion 44 is located between the nut 50 and the connecting shaft 46.

When the nut 50 is tightened to the bolt portion 48, the holding plate 34 is pressed toward the pressure-receiving plate 36. At this time, the four arm portions 42 (see FIG. 1) are elastically deformed. The elastic force (spring force) of the four arm portions 42 is applied to the cell stack 12 as the tightening load via the pressure-receiving plate 36. This tightening load is the holding force of the holding plate 34 with respect to the cell stack 12. The battery frame 16 holds the cell stack 12 by the frictional force generated by the force of the holding plate 34 pushing the cell stack 12 via the pressure-receiving plate 36.

As shown in FIGS. 4A and 4B, the battery module 10 further includes a detachment prevention mechanism 60. The detachment prevention mechanism 60 is a structure for preventing the heat exchanger 20 from being detached from the cell stack 12 (see FIG. 1). In FIG. 4A, the first heat exchanger 20a with the detachment prevention mechanism 60 is illustrated. In FIG. 4B, the second heat exchanger 20b with the detachment prevention mechanism 60 is illustrated.

As shown in FIGS. 4A and 4B, the detachment prevention mechanism 60 protrudes from a peripheral edge portion of the heat exchanger 20 (the first heat exchanger 20a and the second heat exchanger 20b) in a direction along a direction orthogonal to the X-direction. Specifically, as shown in FIG. 2, the detachment prevention mechanism 60 protrudes from the peripheral edge portion of the heat exchanger 20 in the directions along the Y and Z directions.

The detachment prevention mechanism 60 is provided at a site corresponding to each of the four corners of the heat exchange plate 24. As described above, the water supply-drainage header 26 and the turn header 28 are provided at both ends of the heat exchange plate 24, respectively. Therefore, among the four detachment prevention mechanisms 60 (detachment prevention mechanisms 60a, 60b, 60c, and 60d), two detachment prevention mechanisms 60 are provided at the upper and lower portions of the water supply-drainage header 26, respectively. Of the four detachment prevention mechanisms 60, the remaining two detachment prevention mechanisms 60 are provided at the upper and lower portions of the turn header 28, respectively. As described above, when the material of the header 25 (the water supply-drainage header 26 and the turn header 28) is plastic, the detachment prevention mechanism 60 is provided on the header 25 by integral molding.

As shown in FIGS. 4A and 4B, each of the four detachment prevention mechanisms 60 protrudes toward the connecting member 38 (connecting members 38a, 38b, 38c, and 38d) that is in close proximity to each of the detachment prevention mechanisms 60. More specifically, each of the four detachment prevention mechanisms 60 protrudes toward the connecting shaft 46 (connecting shafts 46a, 46b, 46c, 46d) of the connecting member 38 that is in close proximity to each of the detachment prevention mechanisms 60. When no positional shift (displacement) of the heat exchanger 20 in the direction along the direction orthogonal to the X-direction occurs, a gap exists between the connecting shaft 46 and the detachment prevention mechanism 60.

As shown in FIGS. 4A and 4B, in the heat exchanger 20, the detachment prevention mechanism 60a is provided on the upper portion of the header 25 (the water supply-drainage header 26 of the first heat exchanger 20a and the turn header 28 of the second heat exchanger 20b) on the Y1 direction side. The connecting shaft 46a is in close proximity to the upper portion of the header 25 on the Y1 direction side. That is, the connecting shaft 46a is a connecting shaft 46 located on the Y1 direction side among the connecting shafts 46 located above the cell stack 12 (see FIG. 1). The detachment prevention mechanism 60a protrudes from the upper portion of the header 25 on the Y1 direction side toward the connecting shaft 46a.

As shown in FIGS. 4A and 4B, in the heat exchanger 20, a detachment prevention mechanism 60b is provided at a lower portion of the header 25 on the Y1 direction side. The connecting shaft 46b is in close proximity to the lower portion of the header 25 on the Y1 direction side. That is, the connecting shaft 46b is a connecting shaft 46 located on the Y1 direction side among the connecting shafts 46 located below the cell stack 12 (see FIG. 1). The detachment prevention mechanism 60b protrudes from the lower portion of the header 25 on the Y1 direction side toward the connecting shaft 46b.

As shown in FIGS. 4A and 4B, in the heat exchanger 20, the detachment prevention mechanism 60c is provided on the upper portion of the header 25 (the turn header 28 of the first heat exchanger 20a and the water supply-drainage header 26 of the second heat exchanger 20b) on the Y2 direction side. The connecting shaft 46c is in close proximity to the upper portion of the header 25 on the Y2 direction side. That is, the connecting shaft 46c is a connecting shaft 46 located on the Y2 direction side among the connecting shafts 46 located above the cell stack 12 (see FIG. 1). The detachment prevention mechanism 60c protrudes from the upper portion of the header 25 on the Y2 direction side toward the connecting shaft 46c.

As shown in FIGS. 4A and 4B, in the heat exchanger 20, a detachment prevention mechanism 60d is provided at a lower portion of the header 25 on the Y2 direction side. The connecting shaft 46d is in close proximity to the lower portion of the header 25 on the Y2 direction side. That is, the connecting shaft 46d is a connecting shaft 46 located on the Y2 direction side among the connecting shafts 46 located below the cell stack 12 (see FIG. 1). The detachment prevention mechanism 60d protrudes from the lower portion of the header 25 on the Y2 direction side toward the connecting shaft 46d.

By the detachment prevention mechanism 60 being provided in the heat exchanger 20 in this way, when the heat exchanger 20 is displaced by an impact such as vibration in a direction along a direction orthogonal to the X-direction, the detachment prevention mechanism 60 comes into contact with the connecting shaft 46 that faces the detachment prevention mechanism 60. The detachment prevention mechanism 60 is brought into contact with the connecting shaft 46, thereby preventing the heat exchanger 20 from being detached from the cell stack 12.

The detachment prevention mechanism 60 is not limited to the case where it contacts the connecting shaft 46 when the positional shift of the heat exchanger 20 occurs. The detachment prevention mechanism 60 may abut against the connecting shaft 46 when the heat exchanger 20 is not displaced.

Further, the detachment prevention mechanism 60 is not limited to the case where it is provided at the respective sites corresponding to the four corners of the heat exchange plate 24. The detachment prevention mechanism 60 may be provided at two or three of the four sites corresponding to the four corners of the heat exchange plate 24.

The detachment prevention mechanism 60 is provided with an engaging claw 62. The engaging claw 62 is provided at a protruding end portion (tip portion) of the detachment prevention mechanism 60. The engaging claw 62 is engageable with the connecting member 38. Specifically, the engaging claw 62 is formed in an arc shape so as to be engageable with the connecting shaft 46. This makes it easier for the engaging claw 62 to abut against the connecting shaft 46.

As shown in FIG. 4A, a contact portion of the detachment prevention mechanism 60, which is the portion that contacts the connecting shaft 46, has been surface-treated for reducing the friction coefficient. Specifically, a low-friction material 64, which is a substance for reducing the friction coefficient, is provided at the contact portion. Specifically, the low-friction material 64 is provided on the contact surface 66 of the engaging claw 62, which is the surface that comes into contact with the connecting shaft 46. Examples of the low friction material 64 include a coating of a fluorine-based resin such as Teflon (registered trademark in Japan), polyacetal, polyamide, and the like. The low friction material 64 may be a lubricant such as grease. This facilitates relative movement of the first heat exchanger 20a and the second heat exchanger 20b in the X direction when expansion in the X direction occurs due to heat generation or degradation of the battery cell 18. Moreover, the detachment prevention mechanism 60 can be prevented from wearing when the detachment prevention mechanism 60 is brought into contact with the connecting shaft 46.

FIG. 4A shows a case where the low-friction material 64 is provided on the contact surface 66 of the engaging claw 62 of the detachment prevention mechanism 60a. In this embodiment, the low-friction material 64 is also provided on the contact surface 66 of the engaging claw 62 of each of the other detachment prevention mechanisms 60b, 60c, and 60d.

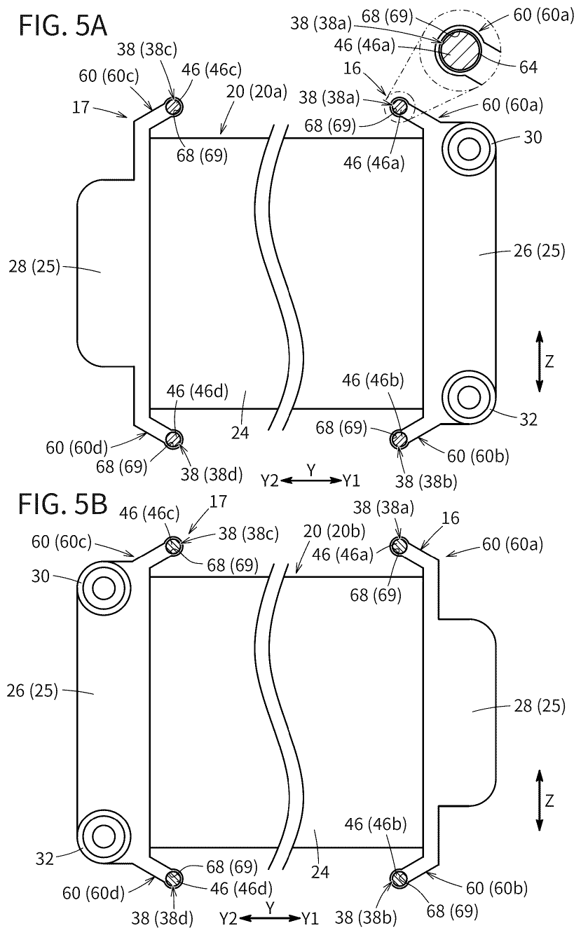

As shown in FIGS. 5A and 5B, the detachment prevention mechanism 60 may include an insertion hole 68 through which the connecting shaft 46 is inserted, instead of the engaging claw 62 (see FIGS. 4A and 4B). The insertion hole 68 penetrates in the X-direction at the protruding end portion of the detachment prevention mechanism 60. The inner diameter of the insertion hole 68 is larger than the outer diameter of the connecting shaft 46. Thus, when the heat exchanger 20 is displaced in a direction along a direction orthogonal to the X-direction, the connecting shaft 46 is brought into contact with an inner peripheral surface 69 of the insertion hole 68. The connecting shaft 46 is brought into contact with the inner peripheral surface 69 of the insertion hole 68, whereby it is possible to effectively prevent the heat exchanger 20 from being detached from the cell stack 12.

The inner peripheral surface 69 of the insertion hole 68 is a contact surface of the detachment prevention mechanism 60, which is the surface that comes into contact with the connecting shaft 46. Surface treatment for reducing the friction coefficient is applied to the inner peripheral surface 69 of the insertion hole 68. That is, the low-friction material 64 is provided on the inner peripheral surface 69 of the insertion hole 68.

FIG. 5A shows a case where the low-friction material 64 is provided on the inner peripheral surface 69 of the insertion hole 68 of the detachment prevention mechanism 60a. In this embodiment, the low friction material 64 is also provided on the inner peripheral surface 69 of the insertion hole 68 of each of the other detachment prevention mechanisms 60b, 60c, and 60d.

In this embodiment, the detachment prevention mechanisms 60 may be provided at the four corners of the heat exchange plate 24. Since the material of the heat exchange plate 24 is metal as described above, the detachment prevention mechanisms 60 are provided at the four corners of the heat exchange plate 24 by welding.

According to the present embodiment, the following effects are obtained.

Even when an impact exceeding the expectation is applied to the battery module 10, as shown in FIGS. 4A-5B, the detachment prevention mechanism 60 is brought into contact with the connecting member 38, whereby the heat exchanger 20 is prevented from being detached from the cell stack 12 (see FIG. 1). In addition, because it is not necessary to increase the tightening force exerted by the holding mechanism 17, the tightening force acting on the battery cell 18 can be prevented from becoming too large when the battery cell 18 expands because of heat generation or deterioration of the battery cell 18. Therefore, in the present embodiment, the cell stack 12 can be held well.

The detachment prevention mechanism 60 protrudes from the peripheral edge portion of the heat exchanger 20 in a direction along a direction orthogonal to the X-direction. Thus, even if the heat exchanger 20 is shifted (displaced) in the direction orthogonal to the X-direction, the detachment prevention mechanism 60 provided in the heat exchanger 20 is brought into contact with the connecting member 38, and thus detachment of the heat exchanger 20 from the cell stack 12 can be effectively prevented.

As shown in FIGS. 4A and 4B, the detachment prevention mechanism 60 includes the engaging claw 62 engageable with the connecting shaft 46 of the connecting member 38. Thus, when the heat exchanger 20 is shifted in the direction orthogonal to the X-direction, the engaging claw 62 engages the connecting shaft 46. As a result, detachment of the heat exchanger 20 from the cell stack 12 (see FIG. 1) can be more effectively prevented.

As shown in FIGS. 5A and 5B, the detachment prevention mechanism 60 is provided with the insertion hole 68 through which the connecting shaft 46 of the connecting member 38 is inserted. Thus, when the heat exchanger 20 is displaced in the direction orthogonal to the X-direction, the connecting shaft 46 is brought into contact with an inner peripheral surface 69 of the insertion hole 68. As a result, detachment of the heat exchanger 20 from the cell stack 12 (see FIG. 1) can be more effectively prevented.

As shown in FIGS. 4A-5B, the heat exchanger 20 has a rectangular heat exchange plate 24, and the detachment prevention mechanism 60 is provided at a site corresponding to each of the four corners of the heat exchange plate 24. Thus, when the heat exchanger 20 is shifted in the direction orthogonal to the X-direction, any one of the detachment prevention mechanisms 60 is brought into contact with the connecting shaft 46. As a result, detachment of the heat exchanger 20 from the cell stack 12 (see FIG. 1) can be efficiently prevented.

The detachment prevention mechanism 60 is provided at each of the pair of headers 25 provided at both ends of the heat exchange plate 24. This prevents detachment of the heat exchanger 20 from the cell stack 12 without degrading the cooling performance of the battery cell 18 with the heat exchange plate 24.

The contact surface (contact surface 66, inner peripheral surface 69 of the insertion hole 68) of the detachment prevention mechanism 60, which is the surface in contact with the connecting member 38, has been surface-treated for reducing the friction coefficient. This can prevent the detachment prevention mechanism 60 from wearing when the detachment prevention mechanism 60 is brought into contact with the connecting member 38.

When no positional shift (displacement) of the heat exchanger 20 in the direction along the direction orthogonal to the X-direction occurs, a gap exists between the connecting shaft 46 and the detachment prevention mechanism 60. This facilitates the relative movement of the heat exchanger 20 in the X direction when expansion in the X direction occurs due to heat generation or degradation of the battery cell 18. When the heat exchanger 20 is displaced in a direction along a direction orthogonal to the X-direction, the detachment prevention mechanism 60 easily abuts against the connecting shaft 46.

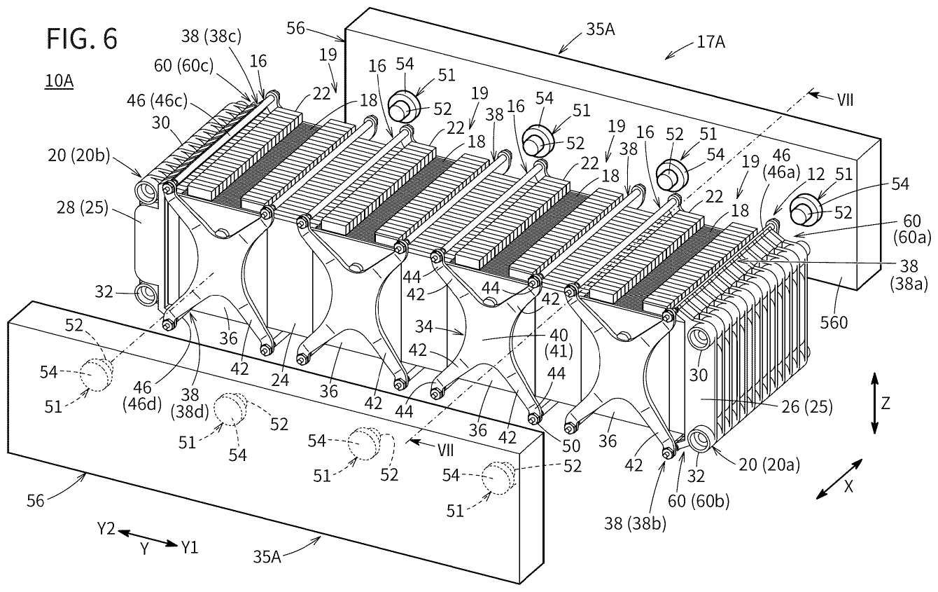

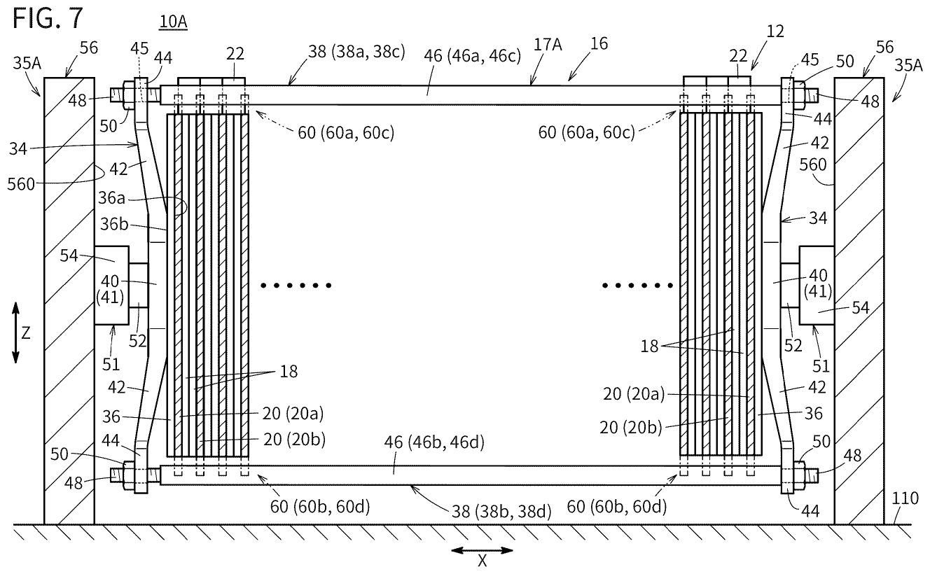

A battery module 10A according to a first modified example will be described with reference to FIGS. 6 and 7. The battery module 10A according to the first modified example includes the cell stack 12 and a holding mechanism 17A.

The holding mechanism 17A includes a plurality of battery frames 16 and a pair of holding portions 35A. In the first modified example, the plurality of battery frames 16, the pair of holding portions 35A, and the plurality of connecting members 38 constitute the holding mechanism 17A for holding the cell stack 12. Each of the pair of holding portions 35A is provided with a plurality of damper members 51 and a support member 56.

The cell stack 12 is pressed inward in the stacking direction by the damper members 51 of the pair of holding portions 35A. Specifically, each of the damper members 51 of the pair of holding portions 35A presses the cell stack 12 inward in the stacking direction via the holding plate 34 and the pressure-receiving plate 36. For this reason, the holding plate 34 is placed between the cell stack 12 and the damper member 51.

The damper member 51 presses the holding plate 34 toward the cell stack 12. The damper member 51 has an elastic body 52 and a holder 54.

The elastic body 52 is a damper body. The elastic body 52 is formed of a material exhibiting rubber elasticity. The elastic body 52 is made of a rubber material or an elastomer material. The elastic body 52 is in contact with the holding plate 34. The elastic body 52 has a circular shape when viewed from the stacking direction. The elastic body 52 may have an elliptical shape or a polygonal shape when viewed from the stacking direction.

The elastic body 52 is in contact with the plate central portion 40 of the holding plate 34. The holder 54 holds the elastic body 52. The holder 54 is formed of a material with higher rigidity than the elastic body 52. The holder 54 is made of, for example, metal.

A plurality of damper members 51 are arranged with a space between each other in the Y direction. Specifically, the damper members 51 are respectively arranged at positions overlapping the cell arrays 19 when viewed from the stacking direction. Since four cell rows 19 are arranged in the Y direction, four damper members 51 are also arranged in the Y direction in the first modified example.

The pair of support members 56 support the damper members 51, respectively. Each of the pair of support members 56 has an opposing surface 560 that faces the holding plate 34. The damper member 51 is fixed to the opposing surface 560. Thus, the damper member 51 is placed between the holding plate 34 and the support member 56. Although not shown in detail, the damper members 51 are fixed to the pair of support members 56 with appropriate fixing components (for example, bolts). Each of the pair of support members 56 is fixed to a floor 110 of an installation target (e.g., the mobile body 100 shown in FIG. 9) in which the battery module 10A is installed.

The first modified example has the following effects.

As shown in FIGS. 6 and 7, each of the pair of holding portions 35A has a damper member 51 that presses the cell stack 12 in the X direction and a support member 56 that supports the damper member 51. Thus, because the holding mechanism 17A having the damper member 51 presses the cell stack 12 inward in the stacking direction, the resonance frequency of the cell stack 12 in the stacking direction can be increased. Therefore, the resonance of the cell stack 12 caused by the external vibration is suppressed and thus the cell stack 12 can be protected. Further, since the support member 56 supports the damper member 51, a tightening load given by the damper member 51 supported by the support member 56 can be applied to the cell stack 12 in addition to a tightening load given by the pair of holding plates 34. Thus, the resonant frequency of the cell stack 12 can be effectively increased.

Each of the pair of holding portions 35A has an elastically deformable holding plate 34. The holding plate 34 is located between the cell stack 12 and the damper member 51. The damper member 51 presses the holding plate 34 toward the cell stack 12. Thus, because the damper member 51 and the holding plate 34 apply a tightening load to the cell stack 12, the resonant frequency of the cell stack 12 can be effectively increased.

The holding plate 34 has a plate central portion 40 (pressing portion 41) and a plurality of arm portions 42 extending radially from the plate central portion 40 in the direction orthogonal to the X-direction. The damper member 51 presses the plate central portion 40 toward the cell stack 12. According to such a configuration, the influence of the vibration at the arm portion 42 of the holding plate 34 can be reduced and thus the resonance frequency of the cell stack 12 can be effectively increased.

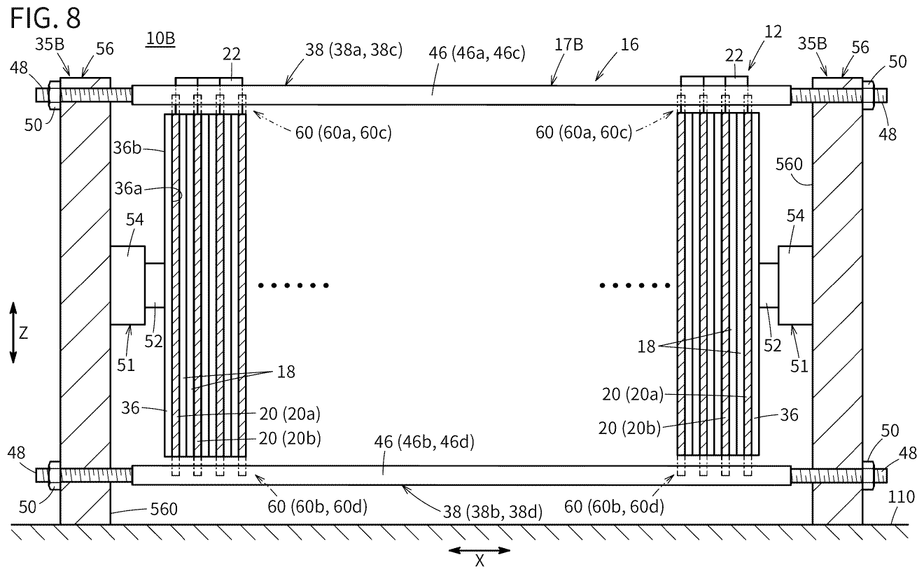

A battery module 10B according to a second modified example will be described with reference to FIG. 8. The battery module 10B according to the second modified example includes the cell stack 12 and a holding mechanism 17B. The holding mechanism 17B is provided with a plurality of battery frames 16 and a pair of holding portions 35B.

The holding mechanism 17B does not have a holding plate 34 (see FIG. 6). The connecting members 38 are connected to the support members 56 of the pair of holding portions 35B. The damper member 51 supported by each of the pair of support members 56 applies a tightening load to the cell stack 12 via the pressure-receiving plate 36. In this case, it is possible to adjust the tightening load to the desired one by adjusting the tightness of the nut 50 with respect to the bolt portion 48. It should be noted that the connecting members 38 may be fixed with respect to the pair of support members 56 in a non-adjustable manner and instead, the support members 56 may be fixed with respect to the floor 110 in an adjustable manner.

With respect to the above embodiments, we further disclose the following supplementary note.

### Supplemental Note 1

A battery module (10, 10A, 10B) of the present disclosure includes: a cell stack (12) including a battery cell (18) and a heat exchanger (20) stacked on the battery cell; a holding mechanism (17, 17A, 17B) including a pair of holding portions (35, 35A, 35B) configured to hold the cell stack by pressing, inward in a stacking direction of the cell stack, both end portions of the cell stack in the stacking direction (X), and a connecting member (38) configured to connect the pair of holding portions to each other; and a detachment prevention mechanism (60) provided at the heat exchanger and preventing, by abutting against the connecting member, the heat exchanger from being detached from the cell stack.

### Supplemental Note 2

In respect of the battery module described in Supplemental note 1, the detachment prevention mechanism may protrude from a peripheral edge of the heat exchanger in a direction along a direction (Y, Z) orthogonal to the stacking direction.

### Supplemental Note 3

In respect of the battery module described in Supplemental note 2, the detachment prevention mechanism may include an engaging claw (62) engageable with the connecting member.

### Supplemental Note 4

In respect of the battery module described in Supplemental note 2, the detachment prevention mechanism may be provided with an insertion hole (68) through which the connecting member is inserted.

### Supplemental Note 5

In respect of the battery module according to any one of Supplemental notes 2 to 4, the heat exchanger may include a heat exchange plate (24) that is rectangular, and the detachment prevention mechanism may be provided at a site corresponding to each of four corners of the heat exchange plate.

### Supplemental Note 6

In respect of the battery module described in Supplemental note 5, the detachment prevention mechanism may be provided at each of a pair of headers (25) provided at both ends of the heat exchange plate.

### Supplemental Note 7

In respect of the battery module according to any one of Supplemental notes 1 to 6, a contact portion of the detachment prevention mechanism that is a portion abutting against the connecting member may be surface-treated for reducing a friction coefficient.

### Supplemental Note 8

In respect of the battery module according to any one of Supplemental notes 1 to 7, a gap may exist between the connecting member and the detachment prevention mechanism when the heat exchanger is not displaced in a direction intersecting the stacking direction, and the detachment prevention mechanism may abut against the connecting member due to displacement of the heat exchanger in the direction intersecting the stacking direction.

### Supplemental Note 9

In respect of the battery module according to any one of Supplemental notes 1 to 8, each of the pair of holding portions may include a damper member (51) that presses the cell stack in the stacking direction, and a support member (56) that supports the damper member.

### Supplemental Note 10

In respect of the battery module described in Supplemental note 9, each of the pair of holding portions may further include a holding plate (34) that is elastically deformable, the holding plate may be placed between the cell stack and the damper member, and the damper member may press the holding plate toward the cell stack.

### Supplemental Note 11

In respect of the battery module described in supplemental note 10, the holding plate may include a pressing portion (41), and a plurality of arm portions (42) extending radially from the pressing portion in a direction orthogonal to the stacking direction, and the damper member may press the pressing portion toward the cell stack.

### Supplemental Note 12

In respect of the battery module described in Supplemental note 11, the pair of support members may be connected to each other by the connecting member.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A battery module comprising:
a cell stack including a battery cell and a heat exchanger stacked on the battery cell;
a holding mechanism including
a pair of holding portions configured to hold the cell stack by pressing, inward in a stacking direction of the cell stack, both end portions of the cell stack in the stacking direction, and
a connecting member configured to connect the pair of holding portions to each other; and
a detachment prevention mechanism provided at the heat exchanger and preventing, by abutting against the connecting member, the heat exchanger from being detached from the cell stack.

2. The battery module according to claim 1, wherein
the detachment prevention mechanism protrudes from a peripheral edge portion of the heat exchanger in a direction along a direction orthogonal to the stacking direction.

3. The battery module according to claim 2, wherein
the detachment prevention mechanism includes an engaging claw engageable with the connecting member.

4. The battery module according to claim 2, wherein
the detachment prevention mechanism is provided with an insertion hole through which the connecting member is inserted.

5. The battery module according to claim 2, wherein
the heat exchanger includes a heat exchange plate that is rectangular, and
the detachment prevention mechanism is provided at a site corresponding to each of four corners of the heat exchange plate.

6. The battery module according to claim 5, wherein
the detachment prevention mechanism is provided at each of a pair of headers provided at both ends of the heat exchange plate.

7. The battery module according to claim 1, wherein
a contact portion of the detachment prevention mechanism that is a portion abutting against the connecting member is surface-treated for reducing a friction coefficient.

8. The battery module according to claim 1, wherein
a gap exists between the connecting member and the detachment prevention mechanism when the heat exchanger is not displaced in a direction intersecting the stacking direction, and
the detachment prevention mechanism abuts against the connecting member due to displacement of the heat exchanger in the direction intersecting the stacking direction.

9. The battery module according to claim 1, wherein
each of the pair of holding portions includes a damper member that presses the cell stack in the stacking direction, and a support member that supports the damper member.

10. The battery module according to claim 9, wherein
each of the pair of holding portions further includes a holding plate that is elastically deformable,
the holding plate is placed between the cell stack and the damper member, and
the damper member presses the holding plate toward the cell stack.

11. The battery module according to claim 10, wherein
the holding plate includes
a pressing portion, and
a plurality of arm portions extending radially from the pressing portion in a direction orthogonal to the stacking direction, and
the damper member presses the pressing portion toward the cell stack.

12. The battery module according to claim 11, wherein
a pair of the support members are connected to each other by the connecting member.
